(19) United States
(12) Patent Application Publication
(10) Pub. No.: US 2011/0159817 A1
(43) Pub. Date: Jun. 30, 2011

(54) Method and system for managing communications between sensor devices included in a tyre and a sensor coordinator device

(75) Inventors: Marco Sabatini, Milano (IT); Vito Avantaggiati, Vimercate (IT)

(73) Assignee: PIRELLI TYRE S.p.A., Milano (IT)

(21) Appl. No.: 12/654,705

(22) Filed: Dec. 29, 2009

(51) Int. Cl. H04B 7/00

(52) U.S. Cl. 455/66.1

(57) ABSTRACT

A communication method between a sensor device associated with a vehicle tyre and a coordinator device on the vehicle body, includes: wirelessly transmitting data from the sensor device to the coordinator device with ultra wide band signals; at the coordinator device, wirelessly receiving the data transmitted by the sensor device by performing an energy detection of the signals received; wirelessly transmitting data from the coordinator device to the sensor device with narrowband radio signals; and at the sensor device, wirelessly receiving the data transmitted by the coordinator device by performing an envelope detection of the received signals.

### BACKGROUND OF THE INVENTION

1. Field of the Invention

The present invention relates to a method and a system for managing communications between one or more sensor devices, included in a tyre fitted on a vehicle, and a coordinator device, mounted on the vehicle body. Said sensors could comprise for example accelerometers, and/or strain gauges, and/or pressure sensors, and/or temperature sensors.

2. Description of the Related Art

The incorporation of electronic devices within pneumatic tyres is taking a greater importance in order to increase the safety of vehicles. Tyre electronics may include sensors and other components suitable for obtaining information regarding the behavior of a tyre, as well as various physical parameters thereof, such as for example temperature, pressure, number of tyre revolutions, vehicle speed, etc.

Such information may become useful in tyre monitoring and/or alarm systems.

Furthermore, active control/safety systems of the vehicle may be based on information sent from sensor devices included within the tyres.

Active safety systems use information about the external environment of a vehicle to change its behavior in pre-crash time period or during the crash event, with the ultimate goal of avoiding a crash altogether. Initially, active safety systems were primarily focused on improving the vehicle longitudinal motion dynamics, in particular, on more effective braking Anti-lock Braking Systems (ABS) and Traction Control (TC) systems. TC systems prevent the wheel from slipping while improving vehicle stability and steerability by maximizing the tractive and lateral forces between the vehicle's tyre and the road. These systems were followed by more powerful vehicle stability control systems, e.g., Electronic Stability Program (ESP), Vehicle Stability Control (VSC), and Dynamic Stability Control (DSC). These latter systems use both brakes and engine torque to stabilize the vehicle in extreme handling situations by controlling the yaw motion. Active suspension systems are also an important part in vehicle active safety systems. They have been traditionally designed by trading-off three conflicting criteria: road holding, load carrying and passenger comfort. The suspension system has to support the vehicle, provide directional control during handling manoeuvres and provide effective isolation of passengers/payload from road disturbances.

### SUMMARY OF THE INVENTION

The active safety control systems described above are based upon the estimation of vehicle dynamics variables such as forces, load transfer, tire-road friction. The more accurate and “real time” the parameter estimation, the better the overall performance of the control system. Currently, most of these variables are indirectly estimated using on-board sensors, and are not very accurate. Using measurements made by sensors fitted on the vehicle tyres would provide far more accurate estimation of the parameters relevant to the vehicle dynamics.

Setting up a system based on sensors fitted on the vehicle tyres is however a challenging task, for several reasons.

The inside of a tire is a harsh environment experiencing high accelerations (at a speed of 200 Km/hr an acceleration equal to about 3,000 g is experienced inside the inner liner of the tyre), and cannot be reached without taking the tire off the wheel. This situation poses very difficult problems: the high centrifugal acceleration implies that the sensor be light weight, for example not to unbalance the tyre, robust and small.

The fact that the tyre moves continuously with respect to the body of the vehicle forces to choose a wireless communication link for the communications from/to the sensors. However, the communication environment in which the sensor devices and the receiver are located is very harsh: in the immediate vicinity of a sensor device the wheel rim and the wheel arch of the car's body form two large signal reflectors. Both these parts are typically in metal and are curved in such a way that they tend to reflect incident waves back into the area, confining them. Furthermore, the radius of curvature of these two vehicle parts is of the order of the wavelength used for wireless transmission, making reflections much more complex. Also, the sensor device is inside the tyre and has to transmit through the tyre in some way: a true line of sight communication channel cannot be achieved since the tyre, being composed of a metal mesh and rubber, attenuates the signal dramatically.

Another issue is connected to the sensors' power supply; replacing the sensors' batteries is impractical because of the difficulty of reaching inside the tire. Hence, it is of primary importance that the sensor devices power consumption be as low as possible.

The Applicant has found that at least some of the above issues can be solved by using a communication between sensor nodes fitted on vehicles' tyres and a sensor coordinator device exploiting UWB (Ultra Wide Band) transmission for the uplink (from the sensor nodes to the coordinator) and a narrowband transmission for the downlink (from the coordinator to the sensor nodes).

Moreover, the Applicant has found that at least some of the above issues can be solved by using a communication between sensor nodes fitted on vehicles' tyres and a sensor coordinator device exploiting envelope detection for the reception, by the sensor nodes, of the narrowband signals transmitted by the coordinator.

Moreover, the Applicant has found that at least some of the above issues can be solved by using a communication between sensor nodes fitted on vehicles' tyres and a sensor coordinator device exploiting energy detection for the reception, by the coordinator, of the UWB signals transmitted by the sensor nodes.

According to an aspect of the present invention, there is provided a communication method between a sensor device associated with a vehicle tyre and a coordinator device on the vehicle body, the method comprising:
wirelessly transmitting data from the sensor device to the coordinator device with UWB signals;
at the coordinator device, wirelessly receiving the data transmitted by the sensor device by performing an energy detection of the UWB signals;
wirelessly transmitting data from the coordinator device to the sensor device with narrowband signals, and
at the sensor device, wirelessly receiving the data transmitted by the coordinator device by performing an envelope detection of the signals received from the coordinator device.

Said UWB signals may be impulse radio signals generated by modulating a carrier with modulating pulses.

Said modulating pulses are preferably triangular sinusoidal pulses.

Preferably, said carrier has a frequency between 4.2 and 4.8 GHz.

Said transmitting data from the sensor device to the coordinator device with UWB signals may in particular comprise modulating the position in time of the modulating pulses depending on the data to be transmitted.

Said wirelessly receiving the data transmitted by the sensor device by performing an energy detection of the UWB signals may comprise integrating in time signals derived from the received UWB signals.

Said integrating in time preferably comprises performing a plurality of integrations in time of the received signals, each integration being made for a time interval equal to a respective fraction of a chip time.

The time intervals over which the integrations in time are performed are preferably partially overlapping.

Said narrowband radio signals are in particular signals having a bandwidth not exceeding approximately 80 MHz.

Another aspect of the present invention relates to a system comprising:

a sensor device associated with a vehicle tyre;

a sensor coordinator device on the vehicle body in wireless communication relationship with the sensor device,

wherein:

the sensor device comprises a UWB radio transmitter operable to transmit data to the coordinator device using UWB signals;

the coordinator device comprises a UWB radio receiver operable to receive the data transmitted by the sensor device by performing an energy detection of the UWB signals;

and wherein:

the coordinator device comprises a narrowband radio transmitter for transmitting data to the sensor device using narrowband signals, and

the sensor device comprises a narrowband radio receiver operable to receive the data transmitted by the coordinator device by performing an envelope detection of the narrowband signals.

Said UWB transmitter preferably is an impulse radio UWB transmitter adapted for transmitting signals generated by modulating a carrier with modulating pulses.

Said modulating pulses preferably are triangular sinusoidal pulses.

Said carrier may have a frequency between 4.2 and 4.8 GHz.

Said UWB transmitter may be operable to modulate the position in time of the modulating pulses depending on the data to be transmitted.

Said UWB radio receiver is preferably operable to perform an integration in time of signals derived from the received UWB signals.

Said UWB radio receiver may comprise a plurality of integrators, each integrator being adapted to perform an integration in a respective time interval equal to a fraction of a chip time.

The time interval of an integrator of the plurality of integrators is preferably partially overlapping with the time interval of another integrator of the plurality of integrators.

Said narrowband radio transmitter may be adapted to transmit signals having a bandwidth not exceeding approximately 80 MHz.

### BRIEF DESCRIPTION OF THE DRAWINGS

These and other features and advantages of the present invention will be made evident by the following description of some exemplary and non-limitative embodiments thereof, to be read in conjunction with the attached drawings, wherein:

FIG. 1 schematically shows an architecture of a system of tyre sensors according to an embodiment of the present invention;

FIG. 2 schematically shows an equatorial section of a tyre having three sensor devices disposed on the liner internal surface, according to an embodiment of the present invention;

FIG. 3 is a functional block diagram of the architecture of a tyre sensor device according to an embodiment of the present invention;

FIG. 4 is a functional block diagram of an acquisition subsystem of a tyre sensor device according to an embodiment of the present invention;

FIG. 5 depicts comparative time-domain and frequency-domain diagrams of a rectangular sinusoid pulse and of a triangular sinusoid pulse usable in an IR UWB transmission scheme adopted in an embodiment of the present invention;

FIG. 6 depicts a modulation scheme according to an embodiment of the present invention;

FIG. 7 is a schematic functional block diagram of a UWB transmitter according to an embodiment of the present invention;

FIG. 8 depicts a train of triangular sinusoid pulses modulated using PPM, and an individual pulse, according to an embodiment of the present invention;

FIG. 9 is a block diagram of a receiver on a tyre sensor device;

FIG. 10 is a functional block diagram of the coordinator device;

FIG. 11 is a functional block diagram of an analog front-end of a UWB receiver on a coordinator device according to an embodiment of the present invention;

FIG. 12 is a functional block diagram of a digital baseband processing section of the UWB receiver in the coordinator device; and

FIG. 13 is a functional block diagram of a transmitting section of the coordinator device.

### DETAILED DESCRIPTION OF EXEMPLARY EMBODIMENTS OF THE INVENTION

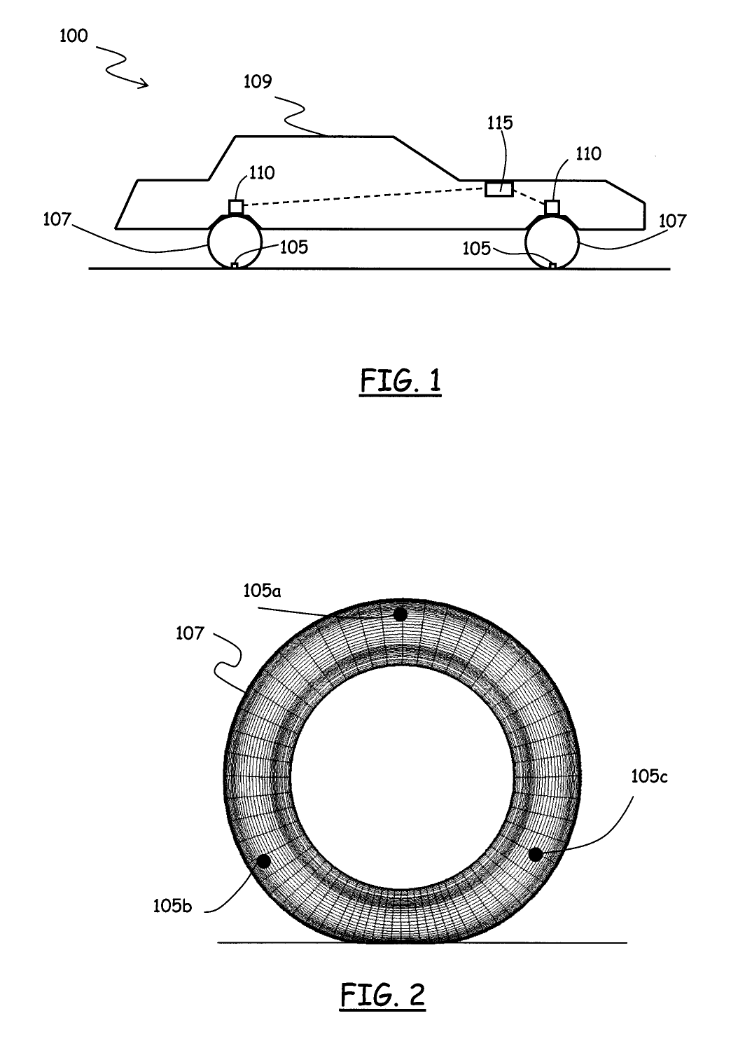

Making reference to the drawings, in FIG. 1 there is schematically shown an exemplary architecture of a system of tyre sensors according to an embodiment of the present invention.

The main components of the system are organized in a hierarchical manner in a Personal Area Network (PAN) defined as a collection of associated and cooperating devices.

At the lowest hierarchical level, the tyre sensor devices form sensor nodes 105, located inside the tyres 107 fitted on a vehicle 109, that are responsible for data acquisition, processing and transmission to the in-vehicle equipment. The sensor devices can be accelerometers, and/or strain gauges, and/or pressure sensors, and/or temperature sensors.

Typically, a vehicle tyre comprises an internally hollow toroidal structure formed by a plurality of components, primarily by a carcass, terminating in two beads, each formed along an inner circumferential edge of the carcass, for securing the tyre to a corresponding supporting rim. At least one pair of annular reinforcing cores, called bead cores, are inserted in the said beads. The carcass is a supporting structure formed by at least one reinforcing ply which includes textile or metallic cords, axially extending from one bead to the other according to a toroidal profile, the ends of which are associated with a corresponding bead core. In radial tyres, the aforesaid cords lie essentially in planes containing the axis of rotation of the tyre. In a radially external position to the carcass, an annular structure is placed, known as belt structure, typically comprising one or more strips of rubberized fabric, wound on top of each other. A tread made from elastomeric material is also added, wound around the belt structure, and usually molded with a relief pattern for the rolling contact of the tyre with the road. Two sidewalls, made from elastomeric material, each extending outwards in radial direction from the outer edge of the corresponding bead, are also placed on the carcass, in axially opposed positions. In tubeless tyres the inner surface of the carcass is normally covered with at least one liner layer, i.e. with one or more layers of airtight elastomeric material. The tyre may further comprise other known elements, such as edges, strips and fillers, according to the specific design of the tyre.

The sensor node 105 is preferably placed on the internal surface of the tyre, on the inner liner surface.

One or more sensor nodes may be placed inside each tire, to increase the accuracy and reliability of the measurements performed. For example three sensors nodes 105a, 105b, 105c may be located at an angle of 120° with respect to each other, as depicted in FIG. 2. This configuration allows improving the knowledge of spatial variation of tire/road interaction parameters. Typically, the sensor nodes 105a, 105b, 105c are located substantially on the equatorial plane of the tyre. Alternatively or in combination, in an embodiment not shown in the figures, a plurality of sensor nodes can be disposed substantially on the same meridian (or radial) plane of the tyre, with at least one of the sensor nodes located out of the equatorial plane of the tire. This configuration allows improving the knowledge of the tyre/road interaction along the whole width of the tyre footprint (i.e. of the contact region between the tyre and the road), as well as making comparisons between the measurements performed by the different sensors located substantially on the same meridian plane in order to derive information during particular manoeuvres performed by the vehicle (e.g. load transfer during a bend, drift angle etc.).

Referring back to FIG. 1, at an upper level in the PAN hierarchy, one or more PAN coordinators 110 are mounted in the vehicle body. The PAN coordinators 110 are powered by the vehicle main power supply; each PAN coordinator 110 is associated with, and mounted in proximity of a respective vehicle tyre 107, and manages the communication with the sensor nodes 105 in the associated tyre, receiving data from them, and mastering the synchronization of the sensor nodes' transmissions. Having one PAN coordinator 110 associated with each tyre, instead of a single, common PAN coordinator for all the tyres, allows increasing the total throughput by limiting the number of sensors controlled by each coordinator and minimizing the distance between the sensor nodes 105 and the PAN coordinator 110, for a more robust communication between these devices.

The PAN coordinators 110 can be connected to each other via a wired network, possibly exploiting a vehicle system bus such as CAN (Controller Area Network) and FlexRay.

At the highest level of the PAN hierarchy is a system control host 115, a device responsible for coordinating all PAN coordinators 110, interfacing them with the vehicle main control and providing a bridge to the vehicle system bus. The system control host 115 is responsible for transferring commands to the sensor nodes from the vehicle main control system and information acquired by the PAN coordinators 110 to the vehicle main control system via the vehicle system bus. The system control host 115 may be implemented as one of the PAN coordinators 110, having enhanced functions with respect to other PAN coordinators.

The PAN architecture has a cluster tree structure. A cluster tree structure is suitable since sensor nodes 105 need not communicate with each other but only with the respective PAN coordinator 110.

According to an embodiment of the present invention, in order to comply with the several different and sometimes conflicting requirements mentioned in the foregoing, different radio technologies are used for the communications between the generic sensor node 105 and the respective PAN coordinator 110 in uplink (i.e., from the sensor node 105 to the PAN coordinator 110) and downlink (i.e., from the PAN coordinator 110 to the sensor node 105), as will be discussed in detail in the following.

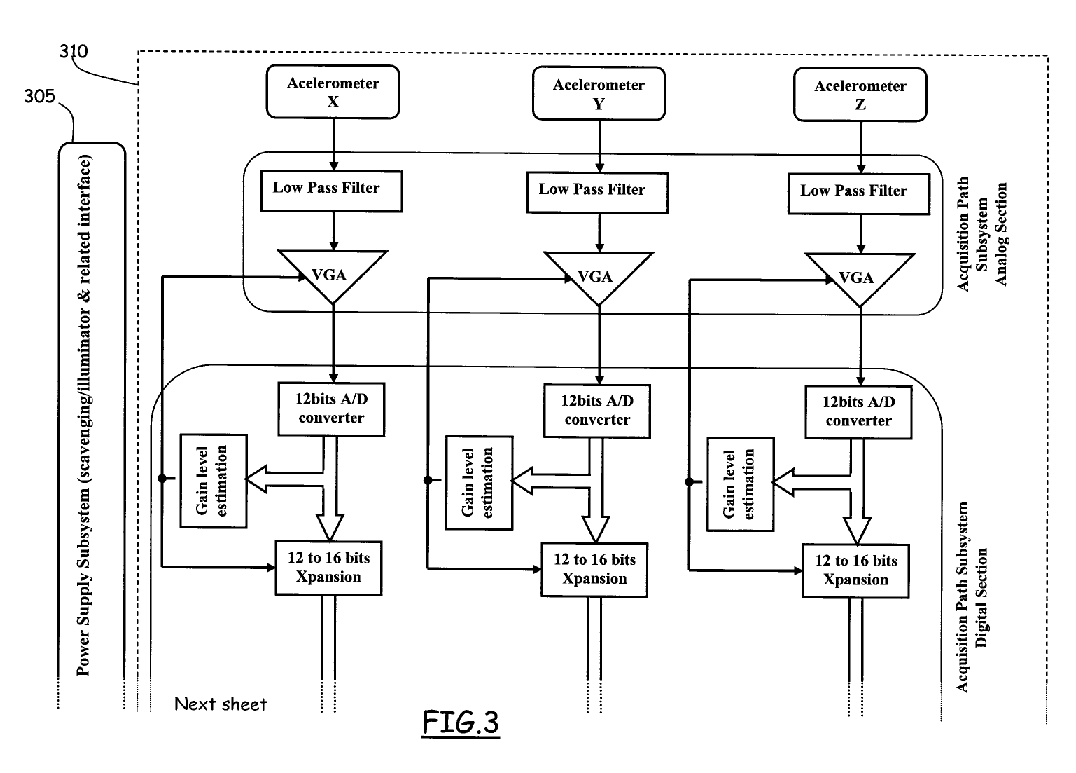

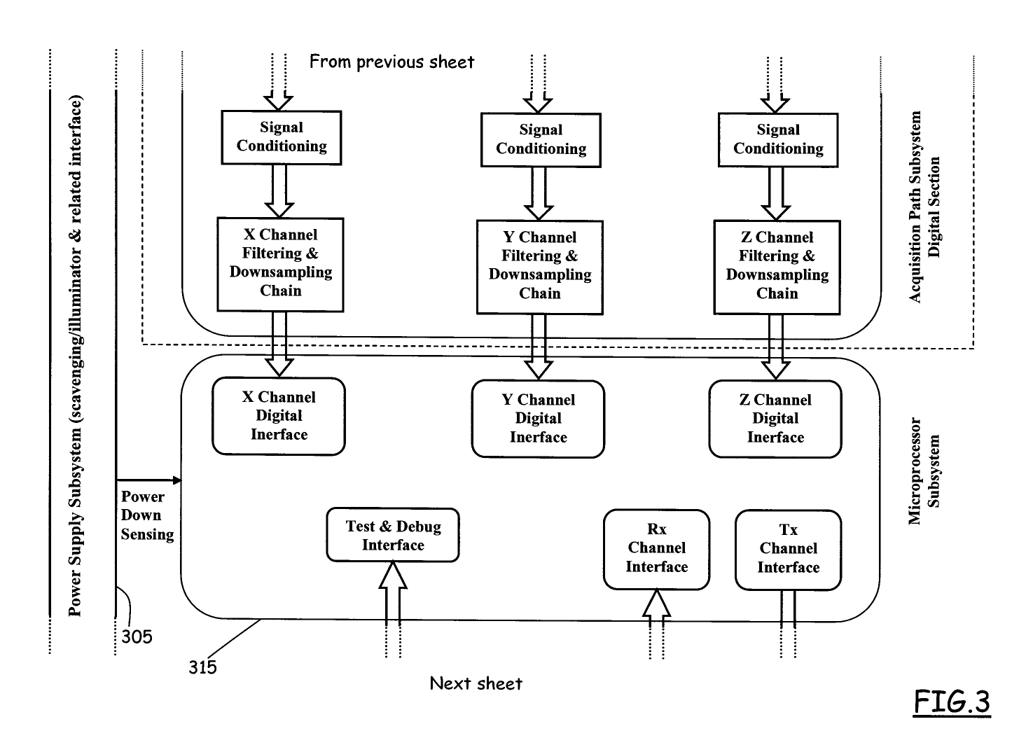

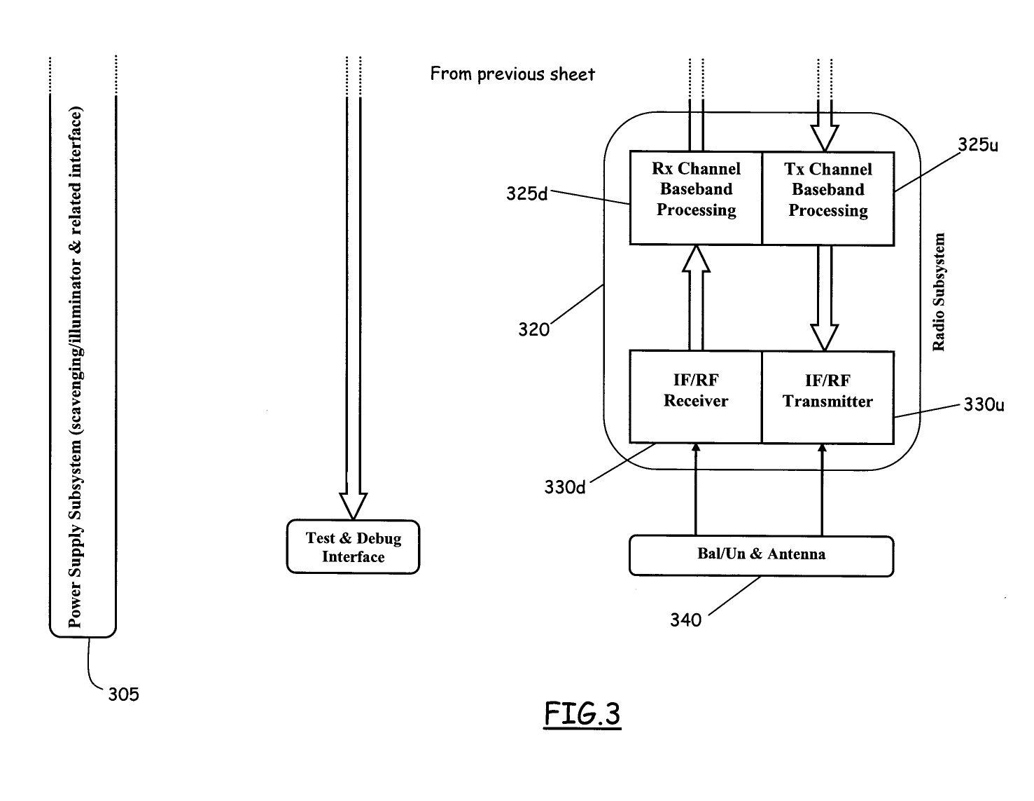

A block diagram of the architecture of a tyre sensor device or sensor node 105 according to an embodiment of the present invention is depicted in FIG. 3.

The generic sensor node 105 is the in-tyre device with the tasks of acquiring data from the tyre, executing preliminary DSP (Digital Signal Processor) processing on them, such as signal conditioning and compensations, and sending data over the RF (RadioFrequency) link to the respective PAN coordinator 110. The sensor node 105 should have a practically unlimited lifetime (so as to be operational for the whole lifetime of the tyre, because replacing a sensor node or a portion thereof due e.g. to malfunctioning can be impractical or even impossible), a small size, be capable of operating in a wide temperature range (from −40° C. in winter up to 100° C. in summer), be robust to high accelerations (an object mounted on the tyre inner lining is subject to a radial acceleration of up to 3,000 g at 200 km/h of vehicle speed).

The sensor node 105 comprises several subsystems, namely: a power supply subsystem 305, a sensor and acquisition path subsystem 310, a control and data processing subsystem 315, a radio subsystem 320.

The power supply subsystem 305 may comprise a battery, however currently available battery technologies may not allow satisfying the long-life requirement for the sensor nodes. Alternative power supply subsystems 305 may provide for scavenging available power at the node, for example scavenging power from the mechanical deformation to which the tyre is subjected during use (e.g. vibrations, deflection at the tire footprint, etc.); electromagnetic, electrostatic, and piezoelectric methods may be exploited to convert mechanical motion into electricity, the amount of power generated by the energy scavenger depending on the technology chosen, on the size of the energy scavenger, and on the environmental conditions such as vibrations, elongation stresses, and temperature gradients. Another method for generating power may be based on electromagnetic coupling; possible methods of providing electromagnetic wireless power transfer include magnetic field coupling via inductive action between two coils, magnetic field coupling via self-resonant coils, and microwave radiation beam via highly directive antennas, by placing an illuminator (a main powered antenna transferring electromagnetic power, via an RF link, to a remote device, wherein the power is collected by means of a suitable receiving antenna) on the wheel.

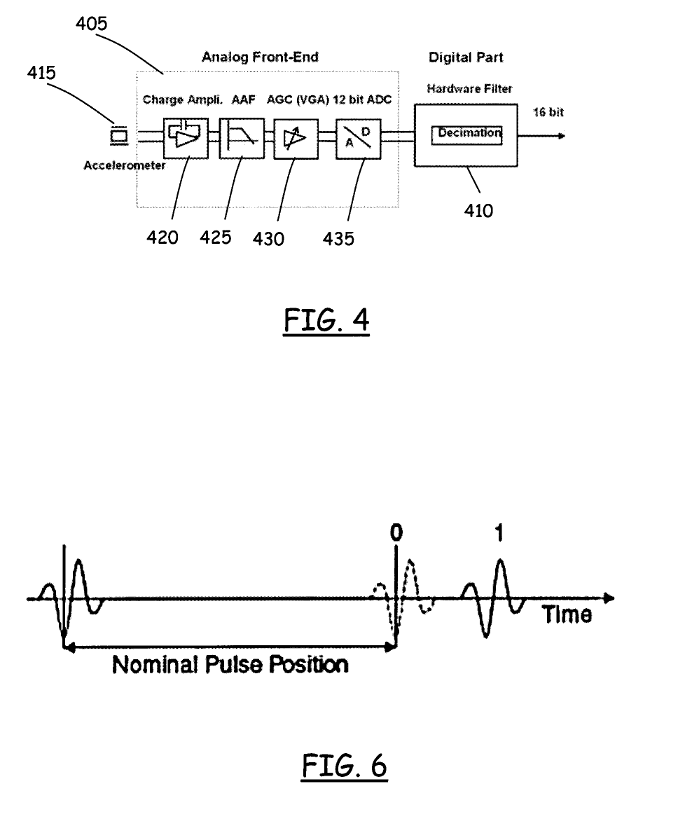

The sensor 313 in the sensor node 105 is for example a triaxial accelerometer, oriented so that the three axes measure signals in the radial, circumferential (tangential) and lateral direction; the sensor produces three data streams (X, Y and Z in FIG. 3). A functional block diagram of the sensor and acquisition path subsystem 310 for one of the three data streams generated by the sensor 313 is depicted in FIG. 4. In the figure, the sensor (e.g., accelerometer) is denoted 400. The data acquisition path comprises an analog front-end section 405 and a digital section 410. The acquisition path subsystem is responsible for the transformation of the signal acquired by the sensor 400 into digital signals. The analog section 405 amplifies and filters the acquired signal from the sensor 400; the analog section comprises for example a charge amplifier 420, a filter 425, a Variable Gain Amplifier (VGA) 430 (implementing an automatic gain control to keep the Signal-to-Noise Ratio—SNR—constant, even at low levels of signal dynamics), and an Analog to Digital Converter (ADC) 435. Then, digitally converted analog data are passed to the digital section 410. Over-sampling techniques may be used, thus signals may be acquired at sampling frequencies higher then their final sampling rate. The digital section is responsible for signal conditioning, in order to correct possible accelerometer imperfections such as offset and bias. In the digital section 410, data are filtered and decimated to the final sampling rate.

Coming back to FIG. 3, the control and data processing subsystem 315 may comprise a single-core DSP responsible of managing the communication protocol, all the functions that control the activity of the sensor node, such as command execution, system monitoring and diagnostics, and the DSP functions like estimation and compensation of signal non-linearity, estimation and compensation of cross-talk among the different accelerometers, estimation of bias and offset, data compression for reducing the input throughput, algorithms required by the communication protocol.

The radio subsystem 320 is responsible for transforming digital data to be sent to the PAN coordinator 110 (on an uplink channel) into analog signals modulated over the desired transmission channel, and for receiving analog data from the PAN coordinator 110 (on a downlink channel) over the transmission channel, and transforming the received data into baseband digital data. The radio subsystem 320 comprises, for the uplink channel, a software driver 325u and a hardware radio transmitter 330u, the latter being coupled to a transmit antenna 340. For the downlink channel, the radio subsystem 320 comprises a hardware radio receiver 330d, coupled to a receiving antenna (which may be the same of the transmit antenna 340, as in the embodiment shown in FIG. 3, or a separate antenna), and a software driver 325d. The transmitter 330u implements the physical layer components, related to channel coding/decoding, modulation and conversions between analog signals to/from digital data, synchronization, and generation of events on a fine-grain time scale (bit or chip level). The software drivers 325u and 325d implement the MAC (Media Access Control) layer and higher network layers components, and manage all events and synchronization requirements at a coarse-grain time scale (frame level). Amplifiers are included in the radio transmission or reception channel, to increase the power of the signal before transmission or before processing.

As mentioned in the foregoing, according to an embodiment of the present invention, different radio technologies are used for the communications between the generic sensor node 105 and the respective PAN coordinator 110 in uplink and downlink; this choice reflects on the architecture of the radio subsystem 320 of the sensor node 105, and the corresponding radio subsystem of the PAN coordinator 110 (to be described later).

As discussed in the foregoing, the communication environment in the PAN of FIG. 1, particularly between the sensor nodes 105 and the PAN coordinator 110, is very harsh. On the other hand, a relevant amount of data needs to be transmitted in uplink, thus transmission at a fairly high data rate, greater than 1 Mbit/s, should be possible; at the same time, the power consumption should be as little as possible, due to the power supply limitations at the sensor nodes, particularly when energy scavenging is used.

According to an embodiment of the present invention, for the uplink transmission, i.e. for the transmission from the sensor node 105 to the PAN coordinator 110, Ultra-Wide-Band (UWB) transmission is adopted.

UWB is a technology that is suitable for low-cost, low-power, short-range wireless data transmission. UWB transmission is robust against inter-symbol interference due to multi-path interference, even severe, and lack of line-of-sight communications. In addition to this, UWB transmission hides signals below the noise floor causing little or no interference to existing systems and mitigates the performance degradation due to narrow-band interference. Low power consumption is achieved thanks to the fact that high power pulses (the power needs to be sufficiently high for the pulses to emerge from the noise floor) are transmitted but using a very low duty cycle, so that the average transmitted power remains low.

Two broad categories of UWB radio systems are known in the art: Impulse Radio (IR) and Multi-Band Orthogonal Frequency-Division Multiplexing (MB-OFDM). IR systems directly generate the UWB frequency spectrum via ultra-short pulses, whereas MB-OFDM is an adaptation of traditional narrowband OFDM technology that forms an aggregate equivalent bandwidth of at least 500 MHz.

The United States Federal Communications Commission (FCC) and the International Telecommunication Union—Telecommunication Standardization Sector (ITU-T) define UWB as any radio technology for which the emitted signal bandwidth exceeds the lesser of 500 MHz and 20% of the center frequency of the modulating signal that forms the pulse, in case of IR, or of the carrier wave in case of OFDM. In 2002, FCC has allocated the 3.1-10.6 GHz band for the unlicensed use of UWB applications; however, these unlicensed UWB systems have to limit energy emission to follow an FCC-defined spectral mask, so that no interference is caused to other existing technologies in the band; in particular, a limit of −41 dBm/MHz on the whole 3.1-10.6 GHz band is set for most devices making use of UWB technology. Conceptually similar energy emission limits in defined spectral masks have been adopted in Europe and in other Countries of the world, although differences exist in the shape of the spectral mask and in the values of the emission limits; for example, in the European Union a maximum mean e.i.r.p. (Equivalent Isotropic Radiated Power) density of −41, 3 dBm/MHz is allowed in the 3.4-4.8 GHz band, provided that a low duty cycle limit is satisfied. In Japan, the allowed frequency bands are 3.4-4.8 GHz and 7.25-10.25 GHz.

Choosing to operate in the frequency band 4.2-4.8 GHz is advantageous, because in this way it is possible to comply with the current different regulations

The Applicant has found that IR UWB technology is better suited to be used for the uplink communications between the sensor nodes 105 and the PAN coordinators 110, thanks to the simple architecture of the uplink transmitter (the part that resides on the sensor nodes 105), which enables low-power high data rate uplink transmission from the sensor nodes 105 to the PAN coordinators 110 on the vehicle.

In IR UWB, the main pulse is first generated, whose frequency response fits in the baseband equivalent of the FCC spectral mask (or corresponding masks defined by other regulatory authorities in different Countries). The pulse is then up-converted to the desired carrier frequency with a carrier pulse.

Any pulse shape can in principle be used for UWB systems, provided that the frequency response satisfies the energy emission limits. Possible pulse shapes for IR UWB systems are Gaussian pulses and their (1st or 2nd) derivatives:

$$x ( t ) = \frac{A}{\sqrt{2 πσ}} exp ( - \frac{{t}^{2}}{2 {σ}^{2}} )$$

where A is the amplitude, and t and σ control the pulse shape.

The frequency spectrums of these pulses have a good behavior compared to other pulse shapes. However the Applicant observed that they are quite difficult to generate and/or control, and a sophisticated transmission-line based design would be required; the center frequency of a Gaussian pulse is also hard to control, since even the slightest change in pulse shape, on the order of picoseconds, can shift the center frequency by hundreds of MHz. In addition, generating Gaussian pulses that fit in the FCC (or equivalent) spectral mask is not trivial; some filter would be needed for the pulse, but this would increase the transmitter complexity, whereas in order to reduce power consumption and size, the uplink transmitter on the sensor node 105 should be as simple as possible.

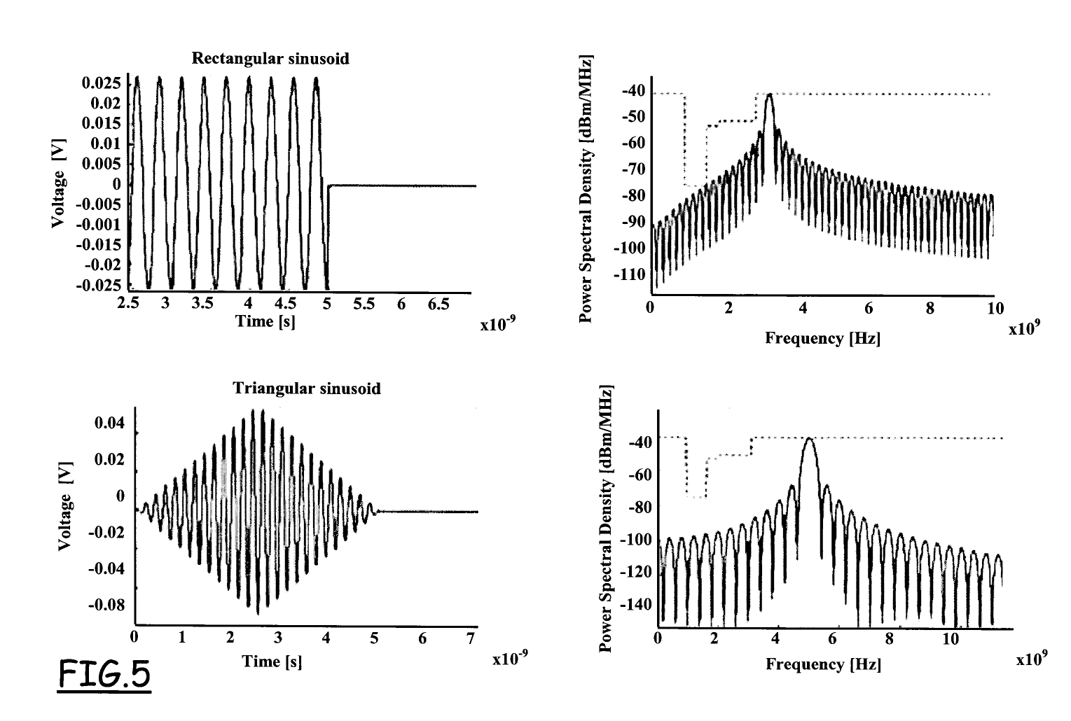

Other possible pulse shapes are rectangular and triangular sinusoids. The Applicant has observed that pulses having the shape of rectangular and triangular sinusoids can be generated without the need of filters or other hardware, and their center frequency is easy to control. The Applicant has also observed that pulses having the shape of a triangular sinusoid better fit in the FCC spectral mask and offers more bandwidth in the main lobe of the frequency response, as depicted in FIG. 5, where a comparison is provided between the time and frequency domain of rectangular sinusoid pulses (upper diagrams in the figure) and triangular sinusoid pulses (lower diagram in the figure). Thus, according to a preferred embodiment of the present invention, IR UWB transmission with triangular sinusoid pulses is adopted, thanks to simplicity of design and greater bandwidth.

Concerning the type of modulation, according to an embodiment of the present invention a binary modulation scheme is adopted, since the Applicant observed that more complex modulation schemes would increase power consumption at the sensor nodes 105, due to the necessity of implementing more complex architectures.

Possible binary modulation schemes include Pulse-Amplitude-Modulation (PAM), On-Off Keying (OOK), Pulse-Position-Modulation (PPM), and Binary Phase-Shift-Keying (BPSK).

BPSK is a particular case of PAM, in which the “0” and “1” binary digits are represented by analog signals having two distinct peak amplitudes. Possible amplitude values for binary PAM are −Vdd for the “0” digit, and Vdd for “1” digit, where Vdd is the supply voltage value. The Applicant has observed that while PAM is advantageous because it is relatively simple to implement, without the need of providing any additional components to the UWB transmitter, the difference between the signal amplitudes for the “0” digit and the “1” digit is however small, so that the signal could be extremely sensitive to channel noise and interference.

OOK is another particular case of PAM, in which the amplitude of the “0” digit is 0. The Applicant has observed that this modulation scheme, albeit being even simpler than BPSK (since for “0” digits nothing needs to be transmitted, saving complexity and power consumption), it shares with BPSK the disadvantage of being noise-prone; in addition, in OOK a “0” digit cannot be distinguished from the lack of a signal at the UWB receiver, making timing recovery and synchronization at the UWB receiver more difficult.

In PPM, information is conveyed via the position of a pulse in the time domain with respect to a specific location. For example, a “0” digit is represented by a pulse at the time instant t=0 in a transmission frame, whereas a “1” digit is represented by a pulse shifted by a time δ(lower than the duration of a transmission frame) from time instant t=0. The PPM modulation scheme is exemplified in FIG. 6. The Applicant has observed that PPM is more robust to channel noise than most PAM systems; the binary digit detection process at the receiver may call for detecting the energy difference (“energy detection”) between the “0” digit and the “1” digit location in time, which is a more robust approach than threshold detection used in PAM, and does not complicate the UWB receiver architecture as instead required by coherent architectures such as a matched filter design needed in BPSK to track the phase of the incoming signals, especially in the presence of an unpredictable channel.

On the other hand, PPM requires careful synchronization between the UWB transmitter and the UWB receiver, since the locations of the “0” digit and the “1” digit are critical for this modulation scheme. However, the Applicant has observed that UWB signals have a wide delay spread relative to the pulse width, due to the abundance of multi-path components, which helps in relaxing the synchronization requirements to the order of tens of nanoseconds.

The Applicant has observed that adopting a receiving scheme based on energy detection at the UWB receiver is advantageous because, compared for example to coherent detection receiving schemes that would require carrier phase recovery at the UWB receiver; energy detection makes the transmission more robust even in the harsh environment in which the sensor system is installed, and in particular increases the robustness under severe in-band interference and multi-path effects, and does not require a reference signal in phase with the received carrier. PPM, as discussed above, is suitable for the implementation of energy detection at the UWB receiver. Moreover, PPM, differently from OOK, inherently carries some timing information from the sensor nodes, allowing better synchronization between the sensor nodes and the respective PAN coordinator. Thus, according to a preferred embodiment of the present invention, PPM is adopted at the UWB transmitter, and energy detection is adopted at the UWB receiver, as will be described in detail later on. Such choice advantageously leads to make the UWB receiver architecture simpler.

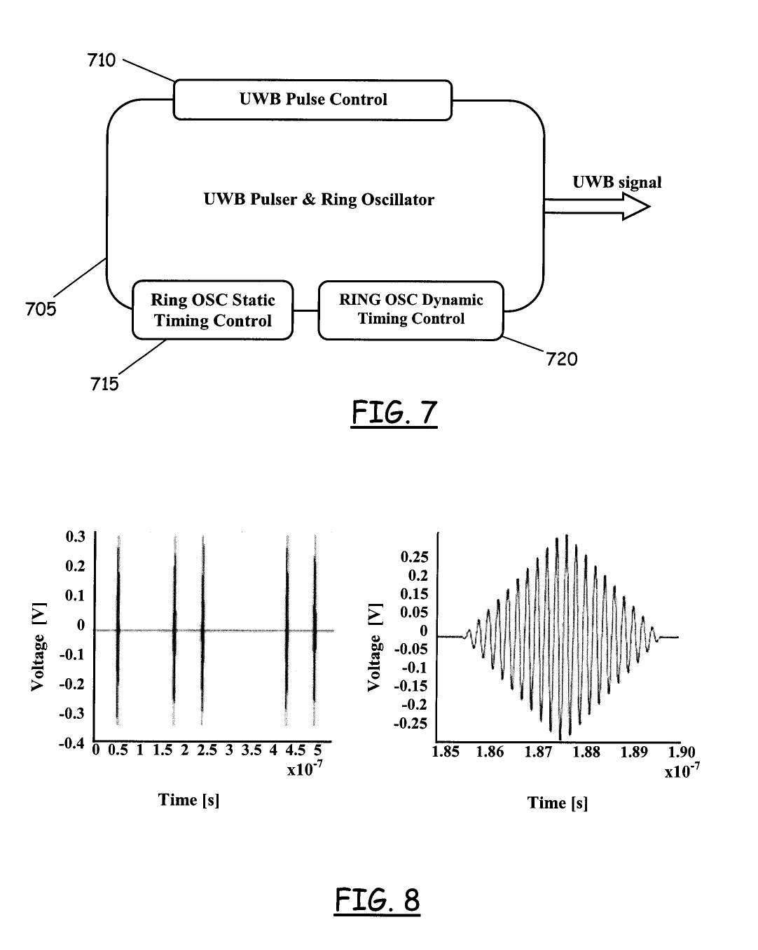

FIG. 7 schematically depicts the architecture of the UWB transmitter, or UWB transmitter front-end, in the radio subsystem 320 of the generic sensor node 105. The UWB transmitter front-end comprises a UWB pulser and ring oscillator 705, the UWB pulser being operable to generate the triangular sinusoid pulses, as discussed above, and the ring oscillator being operable to generate the carrier signal, preferably at a frequency in the range 4.2-4.8 GHz, for example a frequency of approximately 4.5 GHz. A pulse controller 710 is operable to generate the modulated baseband signal, whereas ring oscillator static 715 and dynamic 720 controls control the operation of the ring oscillator.

Triangular sinusoidal pulses modulated using the PPM scheme are thus transmitted by the UWB transmitter at the sensor node 105, as depicted in FIG. 8, wherein the left diagram shows a train of transmitted PPM pulses, whereas the right diagram shows one individual PPM pulse, expanded in the time scale.

For the downlink communications between the PAN coordinators 110 and the sensor nodes 105, the Applicant has observed that only a low data rate (throughput) needs to be sustained, because downlink transmission from the PAN coordinator 110 to sensor node 105 is used primarily to transmit minimal information for coordinating the activities of the sensor nodes (e.g. data acquisition and/or transmission scheduling, packet retransmissions, synchronization etc.), so as to reduce collisions between transmissions from multiple nodes or, more generally, to increase signal-to-noise ratio on the uplink. For example, a throughput of up to 100-200 Kbit/sec may be sufficient for these purposes. Thus, according to a preferred embodiment of the present invention, narrowband transmission, combined with an ultra-low power receiver on the sensor nodes 105 (for saving energy at the sensor nodes) is adopted. For the purposes of the present description, by “narrowband” transmission it is intended a transmission with a bandwidth lower of the UWB bandwidth, of the order of, for example 80 MHz, preferably on a carrier of few GHz, e.g. 2.4-2.5 GHz, or, alternatively, a carrier in the 5.725-5.875 GHz band; this frequency range falls in the unlicensed spectral bands that, according to the most common regulations (e.g., ITU-R) can be exploited by Instrument, Scientific and Medical (ISM) devices.

The receiving section of the radio subsystem 320 in the generic sensor node 105, for the downlink communication from the PAN coordinator 110 to the sensor node 105, is advantageously based on an envelope detection scheme. A receiver based on envelope detection consumes very low power, thanks to its simplicity and to lack of synchronization circuits, and, although the sensitivity of an envelope detector may be not high, in the context of the present invention the transmission power at the PAN coordinator 110 may be raised, because energy consumption by the PAN coordinator 110 is not a critical issue; by raising the transmission power of the PAN coordinator 110, the reduced sensitivity of the envelope detector receiver at the sensor node 105 can be compensated.

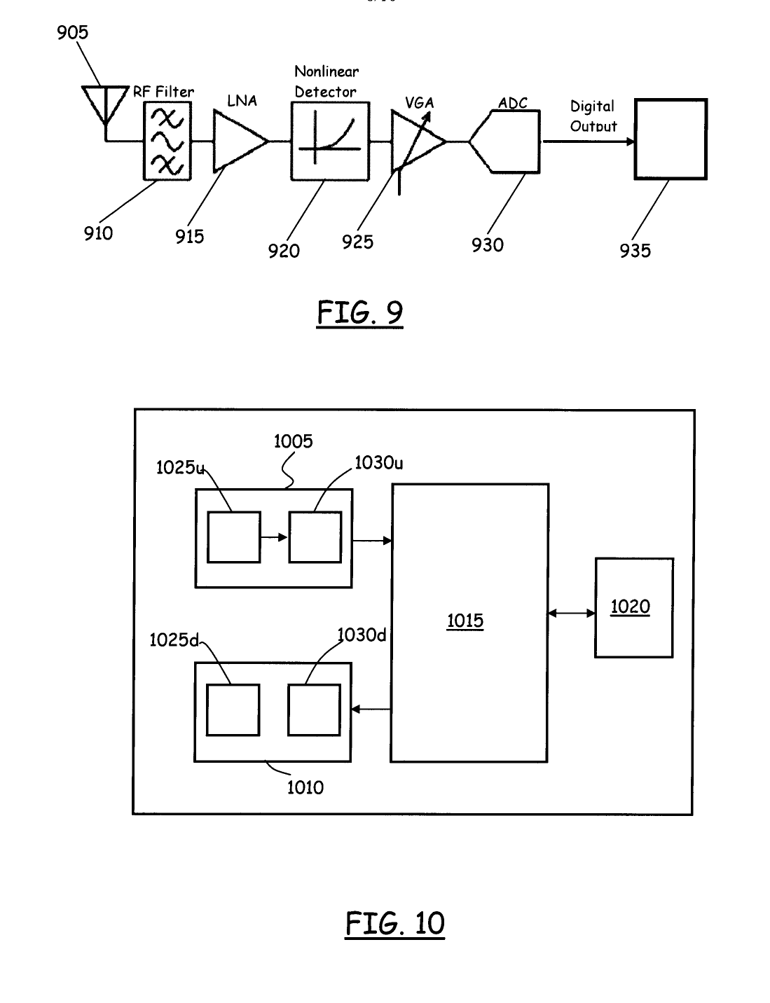

Envelope detection generally calls for determining the absolute value of the received signal, for example exploiting a signal rectifier like a diode, and then filtering out the frequency components not of interest. According to an embodiment of the present invention, the receiving section of the generic sensor node is of the type described in N. Pletcher, S. Gambini, and J. Rabaey, “A 65 μw, 1.9 ghz rf to digital baseband wakeup receiver for wireless sensor nodes,” Proceedings of 2007 Custom Integrated Circuits Conference, San Jose, Calif., USA, September 2007, which is incorporated herein by reference. A preferred embodiment of the receiving section architecture is schematically depicted in FIG. 9.

The basic function of the sensor node receiving section is to determine whether or not RF energy exists in a given frequency band; the downlink transmitted signal is coded for interference mitigation. The receiving section comprises, in addition to an antenna 905, a filter 910, a Low-Noise Amplifier (LNA) 915, a non-linear detector 920, a VGA 925, an ADC 930, and then an energy detector 935, which can for example be implemented as an integrator. The signal received by the antenna 905 is first filtered by the filter 910, so that only the narrow band of interest is admitted. The filter 910 may in particular be a BAW (Bulk Acoustic Wave) filter, implemented by means of MEMS (MicroElectroMechanical System) technology, to reduce power consumption. The filtered RF signal is then amplified by the LNA 915, which provides a modest gain (10-15 dB) while adding minimal noise. The amplified signal is then demodulated by the non-linear detector 920. The resulting signal has power at baseband if there is energy at RF. The signal is then low-pass filtered to detect the energy at baseband. The energy is integrated and the resulting value is then digitized. For downlink transmission, OOK modulation may be used, and bit detection may be accomplished using a single threshold detector on the digitized input stream.

It can be appreciated that no PLL (Phased-Locked Loop), and no local oscillator is employed in the sensor node receiver, in order to save power.

Passing now to the generic PAN coordinator 110, as depicted in FIG. 10 it comprises a receiving section 1005, a transmitting section 1010, a processing section 1015, and an interface section 1020 for interfacing with the system control host 115 (see FIG. 1).

The receiving section 1005 is designed to have good sensitivity to capture the UWB signals transmitted by the sensor nodes in the presence of a harsh communication channel, and to be robust to in-band interference signals and maintain a relatively consistent performance. According to a preferred embodiment of the present invention, an energy detection-based receiver is adopted, because the Applicant has found it to be more sensitive to SNR than other receiver types, like correlation-based receivers (which become very unpredictable in the presence of multi-path effects, because UWB signals have a very rich multi-path profile, which makes correlation-based receivers unreliable to use).

The receiving section 1005 comprises a hardware radio receiver 1025u, coupled to a receiving antenna, and a software driver 1030u. The transmitting section 1010 comprises a software driver 1030d and a hardware radio transmitter 1025d, the latter being coupled to a transmit antenna, which may coincide with the receiver antenna or be a distinct antenna.

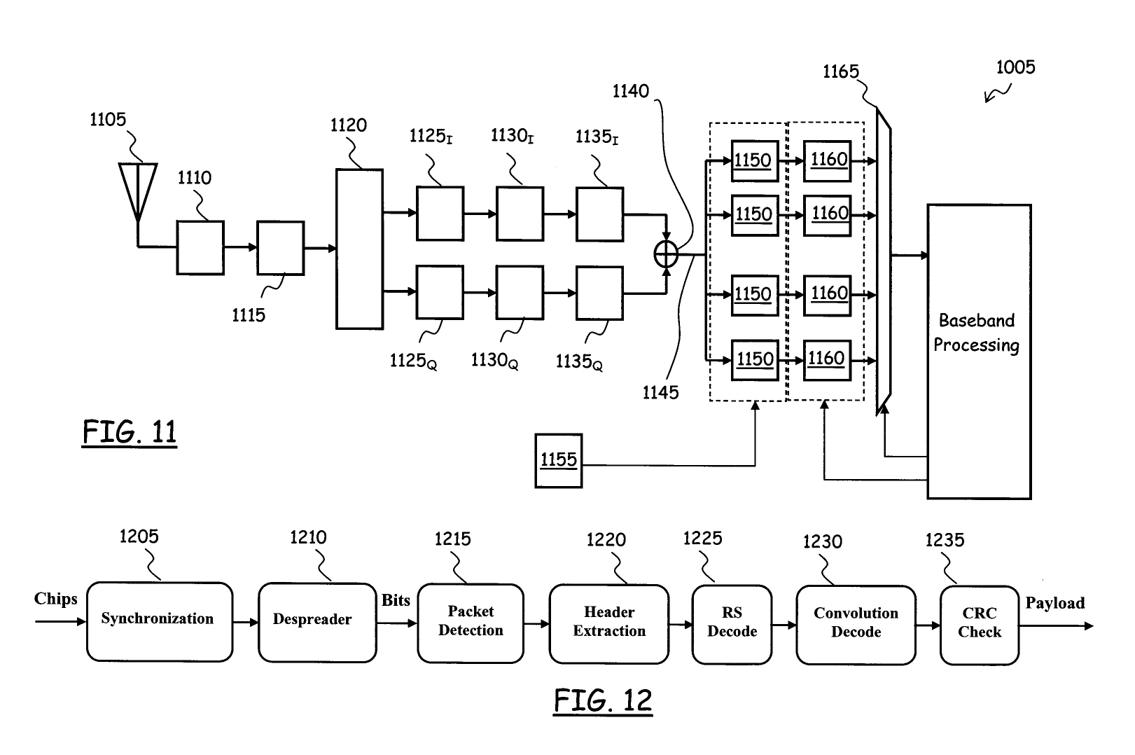

The architecture of the receiving section 1005 of the PAN coordinator 110 is depicted in FIG. 11. The incoming signal band is first down-converted, and then energy detection is performed. The incoming signal is first split into two paths and down-converted in I (In-phase) and (in-Quadrature) channels. The two I and Q signal components are then filtered to remove unwanted higher-order signals. The resulting signals are squared and added to produce the final signal. This signal is an estimate of the power of the modulating signal that is not sensitive to the phase of the incoming signal. The signal is finally integrated and the output (i.e., chips) is sampled and made available to the digital baseband section for detection.

In greater detail, referring to FIG. 11, the UWB signal received from an antenna 1105 is band-pass filtered in 1110 and fed to an LNA 115 (or to a cascade of two or more LNAs), performing a first, low-noise signal amplification, and then it is fed to a mixer 1120 that separates the signal and generates an I and a Q signal components. The I and Q signal components are each low-pass filtered in 1125_{I} and 1125_{Q}, and then fed to respective VGAs 1130_{I} and 1130_{Q}, whose gain is controlled by a gain and synchronization detecting module part of a baseband processing subsystem of the PAN coordinator receiving section. The amplified I and Q signal components are then fed to respective squarer circuits 1135_{I} and 1135_{Q}, added in 1140 to obtain a recombined signal 1145 which is fed to an array of integrators 1150, particularly four integrators in the shown example, controlled by a timing generator 1155 in such a way as to perform an integration of the recombined signal 1145 over partially overlapping time intervals, each corresponding to slightly more than ¼ of the chip time. The integrated values are converted into digital form by four ADCs 1160, and then fed to a multiplexer 1165 controlled by the gain and synchronization detecting module in the baseband processing subsystem, to select the correct ADC output.

Thanks to the fact that the integration of the received signal is performed for time windows that are much longer than the duration of the UWB pulses, the speed of the ADCs can be lowered, from the inverse of the duration of the UWB pulses to the inverse of the duration of the integration time windows; also, once a received UWB pulse is within an integration time window, the integral does not need to depend on the pulse position, but only on the fact that the pulse is contained in such a window or not.

By overlapping the different integration time windows, it is guaranteed that it always exists at least one integration window entirely containing the received UWB pulse: indeed, when the UWB pulse drifts from an integration window to another, it will cross the overlapping zone; provided that this zone is wider than the UWB pulse width, one of the two integration windows always contain the whole UWB pulse to be integrated.

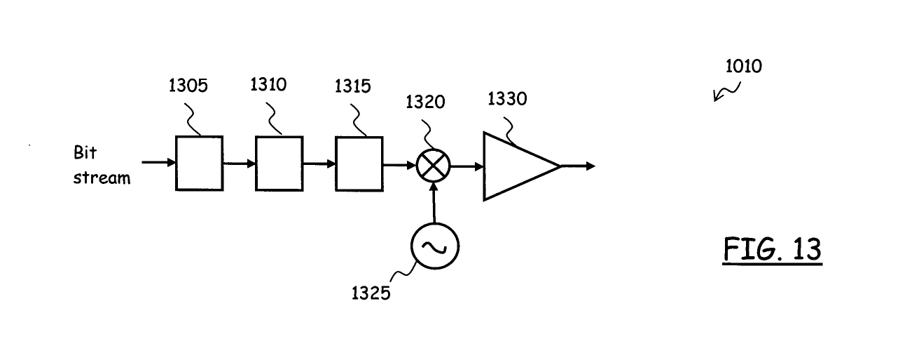

The baseband processing subsystem is schematically depicted in FIG. 12. In an exemplary and non-limitative embodiment of the present invention, the data packet structure and the baseband processing are based on the IEEE 802.15.4a standard. In particular, the baseband processing subsystem essentially comprises, in addition to the gain and synchronization detecting module 1205, a de-spreader 1210, a packet detector 1215, a header extractor 1220, an ECC (Error Correction Code) decoder comprising a Reed-Solomon decoder 1225 and a convolution decoder 1230, and a CRC (Cyclic Redundance Chek) checker 1235.

The gain and synchronization detecting module 1205, using a received preamble, finds the locations of the incoming pulses to synchronize the integrators 1150 in preparation for the incoming data packet. The de-spreader 1210 decodes the incoming chips into bits (an 8-bit pseudo-noise sequence spreading may for example be used to combat channel effects). The packet detector 1215 detects the beginning of a data packet. The header extractor 1220 extracts necessary header information for the subsequent ECC decoding. The ECC decoder uses for example a Reed-Solomon coding scheme (block 1225) and a half-rate convolution decoder (block 1230) to further reduce error. The CRC checker 1235 checks the parity check for assessing the data packet validity.

The transmitting section 1010 of the PAN coordinator is schematically depicted in FIG. 3013; it comprises a narrowband transmitter essentially comprising a digital baseband processing module 1305, a DAC 1310, a low-pass filter 1315, a mixer 1320, a local oscillator 1325 and a power amplifier 1330. The bit stream to be transmitted, for example arriving at a rate between 20-200 Kbit/s, is processed by the digital baseband processing module 1305, which generates a stream of digital symbols at, e.g., 80 MHz (each symbol consisting for example of an 8-bit word). The digital symbols are analog-converted by the DAC 1310, and the resulting analog signal is low-pass filtered 1315, for eliminating out-of-band components. Frequency up-conversion is then performed in the mixer 1320 by mixing the analog signal to be transmitted with a carrier generated by the oscillator 1325, for example at 2.4 GHz. The up-converted signal is then amplified in 1130 and transmitted.

The combination of UWB transmission technique for the uplink communications, and non-UWB, narrowband transmission for the downlink communications, with energy/envelope detection at the receivers' side, allows overcoming the problems of robust communication between the sensor nodes and the PAN coordinators in a harsh environment and with very limited power consumption, especially at the sensor nodes.

In operation, communications between the sensor nodes 105 and the PAN coordinators 110 are regulated by a MAC protocol, that manages communication medium contention between different sensor nodes 105. According to an embodiment of the present invention, TDMA (Time Division Multiple Access) is adopted, because it has several advantages. For example, TDMA allows the sensor nodes to transmit only during the allotted time slot and to enter a sleep mode otherwise, which helps reducing power consumption; during the assigned transmission time, the generic sensor node does not have to contend with any other sensor node for channel access, and this reduces interference and possible delay in throughput. No extra circuitry is needed, thus the energy overhead is very low.

In order to reduce power consumption at the sensor nodes, media access is controlled by sending as little information to the sensor nodes as possible. To this purpose, a MAC protocol is adopted, which is designed for ultra-low-power data-acquisition wireless networks, where the sensor nodes are subject to stringent energy constraints.

The adopted MAC scheme is an Implicitly Scheduled Time Divided-MAC (ISTD-MAC), and is a TDMA protocol that features implicit generation of a transmission schedule using an ordered priority scheme. Each node determines its own allocated time-slot based on very limited information sent by the PAN coordinator via a beacon packet. This implicit method simplifies node receiver architecture and energy consumption. The transmission priority order of the nodes can be preferably determined a-priori to save time and energy during system initialization.

An exemplary communication protocol between the nodes or sensor devices are described in the International application No. WO2009/081425, filed on 20 Dec. 2007, which is incorporated herein by reference.

The previous description presents and discusses in detail several embodiments of the present invention; nevertheless, several changes to the described embodiments, as well as different invention embodiments are possible, without departing from the scope defined by the appended claims.

1-18. (canceled)

19. A communication method between a sensor device associated with a vehicle tyre and a coordinator device on the vehicle body, comprising:
wirelessly transmitting data from the sensor device to the coordinator device with ultra wide band signals;
at the coordinator device, wirelessly receiving the data transmitted by the sensor device by performing an energy detection of the ultra wide band signals;
wirelessly transmitting data from the coordinator device to the sensor device with narrowband signals; and
at the sensor device, wirelessly receiving the data transmitted by the coordinator device by performing an envelope detection of the signals received from the coordinator device.

20. The method of claim 19, wherein said ultra wide band signals are impulse radio signals generated by modulating a carrier with modulating pulses.

21. The method of claim 19, wherein said modulating pulses are triangular sinusoidal pulses.

22. The method of claim 20, wherein said carrier has a frequency between 4.2 and 4.8 GHz.

23. The method of claim 20, wherein said transmitting data from the sensor device to the coordinator device with ultra wide band signals comprise modulating the position in time of the modulating pulses depending on the data to be transmitted.

24. The method of claim 19, wherein said wirelessly receiving the data transmitted by the sensor device by performing an energy detection of the ultra wide band signals comprises integrating in time signals derived from the received ultra wide band signals.

25. The method of claim 24, wherein said integrating in time comprises performing a plurality of integrations in time of the received signals, each integration being made for a time interval equal to a respective fraction of a chip time.

26. The method of claim 25, wherein the time intervals over which the integrations in time are performed are partially overlapping.

27. The method of claim 19, wherein said narrowband radio signals are signals having a bandwidth not exceeding approximately 80 MHz.

28. A system comprising:
a sensor device capable of being associated with a vehicle tyre;
a sensor coordinator device on the vehicle body in wireless communication relationship with the sensor device,
wherein:
the sensor device comprises an ultra wide band radio transmitter capable of transmitting data to the coordinator device using ultra wide band signals;
the coordinator device comprises an ultra wide band radio receiver capable of receiving the data transmitted by the sensor device by performing an energy detection of the ultra wide band signals;
and wherein:
the coordinator device comprises a narrowband radio transmitter capable of transmitting data to the sensor device using narrowband signals; and
the sensor device comprises a narrowband radio receiver capable of receiving the data transmitted by the coordinator device by performing an envelope detection of the narrowband signals.

29. The system of claim 28, wherein said ultra wide band transmitter is an impulse radio ultra wide band transmitter capable of being adapted for transmitting signals generated by modulating a carrier with modulating pulses.

30. The system of claim 29, wherein said modulating pulses are triangular sinusoidal pulses.

31. The system of claim 29, wherein said carrier has a frequency between 4.2 and 4.8 GHz.

32. The system of claim 29, wherein said ultra wide band transmitter is capable of modulating the position in time of the modulating pulses depending on the data to be transmitted.

33. The system of claim 28, wherein said ultra wide band radio receiver is capable of performing an integration in time of signals derived from the received ultra wide band signals.

34. The system of claim 33, wherein said ultra wide band radio receiver comprises a plurality of integrators, each integrator capable of being adapted to perform an integration in a respective time interval equal to a fraction of a chip time.

35. The system of claim 34, wherein the time interval of an integrator of the plurality of integrators is partially overlapping with the time interval of another integrator of the plurality of integrators.

36. The system of claim 28, wherein said narrowband radio transmitter is capable of being adapted to transmit signals having a bandwidth not exceeding approximately 80 MHz.
